(19) United States
(12) Patent Application Publication
(10) Pub. No.: US 2025/0341731 A1
(43) Pub. Date: Nov. 6, 2025

(54) DISPLAY DEVICE

(71) Applicant: SONY GROUP CORPORATION, TOKYO (JP)

(72) Inventors: NORIAKI TAKAHASHI, TOKYO (JP); YUTO KOBAYASHI, TOKYO (JP)

(21) Appl. No.: 18/862,362

(22) PCT Filed: Apr. 27, 2023
(86) PCT No.: PCT/JP2023/016575

§ 371 Date: Nov. 1, 2024

(30) Foreign Application Priority Data
May 12, 2022 (JP) 2022-078791

(51) Int. Cl. G02B 27/28; G02B 5/00; G02B 5/30; G02B 27/00

(52) U.S. Cl. CPC G02B 27/288; G02B 27/0093; G02B 5/003; G02B 5/3066

(57) ABSTRACT

The present disclosure relates to a display device that makes it possible to provide a display device in which dimming of display light is reduced by using a reflection type polarizing plate.

The display device includes a display, a camera, and a reflection type polarizing plate configured to selectively transmit first polarized light having a first polarization direction and selectively reflect second polarized light having a second polarization direction different from the first polarization direction. The reflection type polarizing plate is disposed in an imaging direction of the camera so that the reflection type polarizing plate transmits one of an image of natural light including first polarized light and second polarized light and a video on the display and reflects the other of the image of natural light and the video on the display, and the camera is configured to capture the image of natural light including only one of the first polarized light and the second polarized light provided through the reflection type polarizing plate. The technology of the present disclosure can be applied to, for example, a telecommunication apparatus and the like.

### TECHNICAL FIELD

The present disclosure relates to a display device, and particularly to a display device made so as to be capable of providing a display device in which dimming of display light is reduced by using a reflection type polarizing plate.

### BACKGROUND ART

Conventionally, there has been developed a technique for making lines-of-sights of users coincide with each other in telecommunication. For example, Patent Document 1 discloses a telecommunication device using a polarizing plate and a half mirror.

Meanwhile, in recent years, a technique utilizing a reflection type polarizing plate that can function as a mirror has been disclosed. For example, Patent Document 2 discloses a device in which a reflection type polarizing plate is disposed on a display and functions of a mirror and the display can be switched.

### CITATION LIST

### Patent Document

Patent Document 1: Japanese Patent Application Laid-Open No. H05-199518
Patent Document 2: WO 2016/136100 A1

### SUMMARY OF THE INVENTION

### Problems to be Solved by the Invention

With a configuration of a device using a polarizing plate and a half mirror, since display light is dimmed, video quality lowers.

The present disclosure has been made in view of such a situation, and an object thereof is to be able to provide a display device in which dimming of display light is reduced by using a reflection type polarizing plate.

### Solutions to Problems

A display device according to one aspect of the present disclosure is a display device including: a display; a camera; and a reflection type polarizing plate configured to selectively transmit first polarized light having a first polarization direction and selectively reflect second polarized light having a second polarization direction different from the first polarization direction, in which the reflection type polarizing plate is disposed in an imaging direction of the camera so that the reflection type polarizing plate transmits one of an image of natural light including the first polarized light and the second polarized light and a video on the display and reflects the other of the image of natural light and the video on the display, and the camera is configured to capture the image of natural light including only one of the first polarized light and the second polarized light provided through the reflection type polarizing plate.

In one aspect of the present disclosure, there are provided a display, a camera, and a reflection type polarizing plate configured to selectively transmit first polarized light having a first polarization direction and selectively reflect second polarized light having a second polarization direction different from the first polarization direction, in which the reflection type polarizing plate is disposed in an imaging direction of the camera so that the reflection type polarizing plate transmits one of an image of natural light including the first polarized light and the second polarized light and a video on the display and reflects the other of the image of natural light and the video on the display, and the camera is configured to capture the image of natural light including only one of the first polarized light and the second polarized light provided through the reflection type polarizing plate.

The display device may be an independent device, or may be an internal block that constitutes one device.

### BRIEF DESCRIPTION OF DRAWINGS

FIG. 1 is a side view illustrating a configuration example of a display device as a comparative example.

FIG. 2 is a view for describing a reflection type polarizing plate used in a display device of the present disclosure.

FIG. 3 is a side view illustrating a configuration example of a first embodiment of the display device of the present disclosure.

FIG. 4 is a view for describing a polarization axis of reflected light.

FIG. 5 is a side view for describing a ninth modification example of the first embodiment.

FIG. 6 is a side view illustrating a configuration example of a second embodiment of the display device of the present disclosure.

FIG. 7 is a side view illustrating a configuration example of a third embodiment of the display device of the present disclosure.

FIG. 8 is a side view illustrating a configuration example of a fourth embodiment of the display device of the present disclosure.

FIG. 9 is a side view illustrating a configuration example of a fifth embodiment of the display device of the present disclosure.

FIG. 10 is a block diagram of a video conference system including a telecommunication device to which the display device of the present disclosure is applied.

### MODE FOR CARRYING OUT THE INVENTION

Hereinafter, modes for carrying out the technique of the present disclosure (hereinafter, it is referred to as embodiments) will be described with reference to the accompanying drawings. Note that in the present specification and the drawings, components having substantially the same functional configurations are denoted by the same reference signs, and redundant descriptions are omitted. The description will be given in the following order.
1. Configuration Example of Display Device of Comparative Example
2. Description of Reflection Type Polarizing Plate
3. First Embodiment of Display Device of Present Disclosure
4. Modification Example of First Embodiment
5. Second Embodiment of Display Device of Present Disclosure
6. Third Embodiment of Display Device of Present Disclosure
7. Fourth Embodiment of Display Device of Present Disclosure
8. Fifth Embodiment of Display Device of Present Disclosure
9. Summary of Display Device of Present Disclosure
10. Configuration Example of Video Conference System

### 1. Configuration Example of Display Device of Comparative Example

The present disclosure relates to a display device in which a line-of-sight direction of a user viewing a video displayed on a display is made coincide with an imaging direction of a camera capturing the user. Before describing a configuration of the display device of the present disclosure, a configuration of a display device using a half mirror will be described as a comparative example for comparison with the display device of the present disclosure.

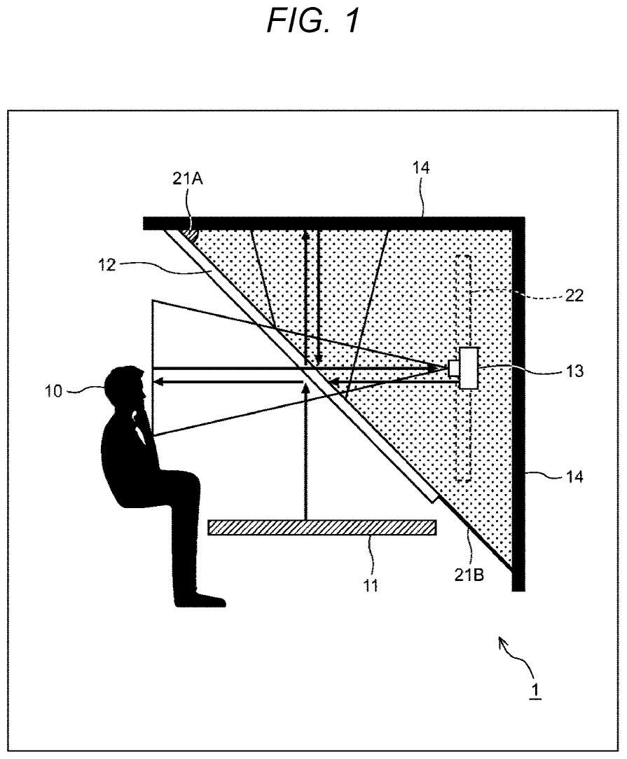

FIG. 1 is a side view illustrating a configuration example of the display device as the comparative example. FIG. 1 is a view of a user viewing a video displayed on the display device as viewed from a lateral direction.

A display device 1 includes a display 11, a half mirror 12, a camera 13, and a black mask 14. A user 10 is seated and viewing a video on the display device 1. The display device 1 is installed in front of the user 10 who is a viewer and views a video and audio output from the display 11.

The half mirror 12 is installed at a position in front of the user and away by a predetermined distance while the half mirror 12 is inclined by 45 degrees to a side of the user, and the display 11 is disposed vertically below the half mirror 12 with a display surface facing upward. The camera 13 is disposed behind the half mirror 12 (in a depth direction), the half mirror 12 being inclined by 45 degrees, so that the camera 13 faces the user 10. The black mask 14 configured to absorb light and reduce reflection of light is disposed on a back surface behind the camera 13 (in the depth direction) as viewed from the user 10 and an upper surface on a side opposite to a side of the display 11 through the half mirror 12, the upper surface being located in a ceiling direction as viewed from the user 10. The half mirror 12 is fixed to each of a ceiling portion of the black mask 14 and a back surface portion of the black mask 14 by fixing portions 21A and 21B, whereby the half mirror 12 is fixed in the air in a state of being inclined by 45 degrees with respect to a floor surface.

The display 11 includes, for example, a liquid crystal display (LCD) and displays a video supplied from a display control unit (not illustrated). The half mirror 12 transmits half of incident light and reflects the other half. The camera 13 captures an image of light (hereinafter, also referred to as subject light) from the user 10 who is a subject.

In the display device 1 having the above configuration, the video displayed on the display 11 is reflected by the half mirror 12 and visually recognized by the user. The camera 13 captures an image of the user 10 through the half mirror 12.

The display device 1 using such a half mirror 12 has the following problems.
(1A) Light from the display 11 is reflected through the half mirror 12, whereby the light is dimmed.
(2A) The subject light whose image is captured by the camera 13 is transmitted through the half mirror 12, whereby the subject light is dimmed.
(3A) Since a scene on a side of the camera 13 is transmitted through the half mirror 12, the scene is visible to the user 10. To make the scene on the side of the camera 13 invisible to the user 10, it is necessary to darken.
(4A) The scene on the side of the camera 13 is reflected through the half mirror 12, whereby an image of the scene is captured by the camera 13.
(5A) It is necessary to fix the half mirror 12 in the air.
(6A) A virtual image on the display 11 is located behind the half mirror 12 (virtual image position 22 illustrated by a broken line in FIG. 1), and a visual distance of the user 10 is restricted. In other words, a position where the user 10 can see the video on the display 11 is limited, for example, there is a case where the video reflected by the half mirror 12 is cut off depending on a position of the user 10.

### 2. Description of Reflection Type Polarizing Plate

As described above, in the display device 1 as the comparative example, since display light is dimmed by using the half mirror 12, video quality lowers. In the display device of the present disclosure as described below, a reflection type polarizing plate is used, whereby it is achieved that the dimming of display light is reduced, and a line-of-sight direction of a user viewing a video displayed on a display is made coincide with an imaging direction of the camera capturing the user.

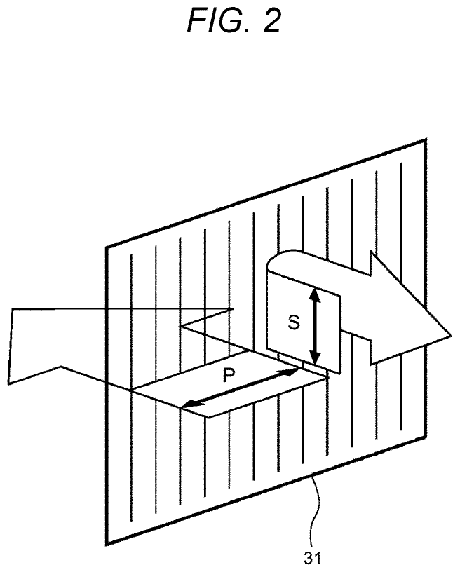

With reference to FIG. 2, the reflection type polarizing plate used in the display device of the present disclosure will be described.

A reflection type polarizing plate 31 is a reflection type polarizing element configured to selectively transmit linearly polarized light in a first direction and selectively reflect linearly polarized light in a second direction orthogonal to the first direction. Hereinafter, description will be given while the linearly polarized light in the first direction that is transmitted will be referred to as p-polarized light and the linearly polarized light in the second direction that is reflected will be referred to as s-polarized light. An axis of the p-polarized light is also referred to as a transmission axis, and an axis of the s-polarized light is also referred to as a reflection axis. Note that although in FIG. 2, a direction of the transmission axis is a lateral direction (horizontal direction), and a direction of the reflection axis is oriented is a longitudinal direction (vertical direction), the directions of the transmission axis and the reflection axis may be any of the lateral direction, the longitudinal direction, and an oblique direction as long as the transmission axis and the reflection axis are orthogonal to each other.

### 3. First Embodiment of Display Device of Present Disclosure

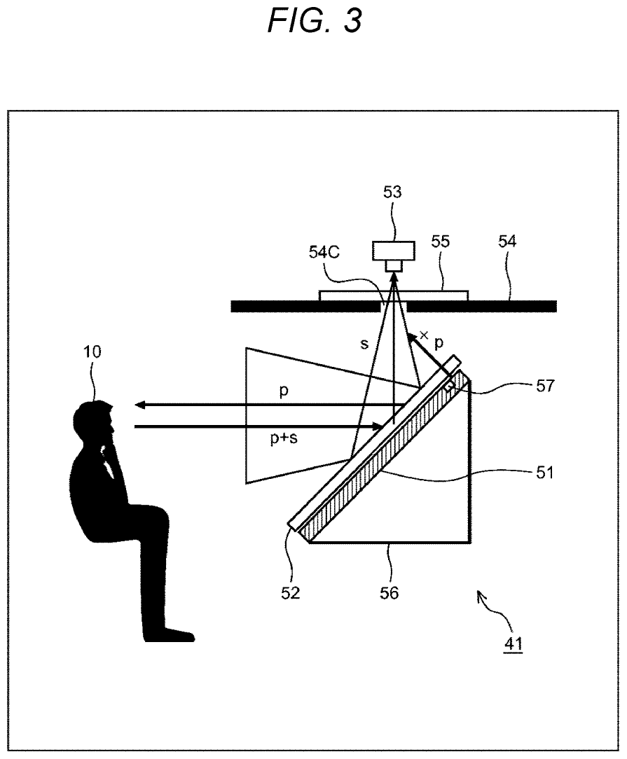

FIG. 3 is a side view illustrating a configuration example of a first embodiment of the display device of the present disclosure. FIG. 3 is a view of a user viewing a video displayed on the display device as viewed from a lateral direction. This similarly applies to second to fifth embodiments as described later.

A display device 41 includes a display 51, a reflection type polarizing plate 52, a camera 53, a black mask 54, and a polarizing filter 55. A user 10 is seated and viewing a video on the display device 41. The display device 41 is installed in front of the user 10 who is a viewer and views the video and audio output from the display 51.

The display 51 is disposed in a state of being inclined at a position in front of the user and away by a predetermined distance, and the reflection type polarizing plate 52 is bonded to a surface of the display 51. The display 51 is attached to a fixing member 56 so that the display 51 is disposed in a state of being inclined while facing upward by 45 degrees with respect to a surface perpendicular to a gravity direction (for example, a floor surface). The display 51 includes a 3D display that enables viewing with naked eyes to view a stereoscopic video and is configured to generate a video based on the gravity direction. More specifically, the display 51 is configured by disposing a stereoscopic optical member such as a lenticular lens or a parallax barrier on a front surface of a video display unit that includes, for example, an LCD. A line-of-sight recognition sensor 57 is disposed at a predetermined position on a display surface of the display 51. The line-of-sight recognition sensor 57 is configured to recognize a position of a viewpoint of the user 10, more specifically, a position and a line-of-sight of a pupil. The display 51 is configured to generate and display a video based on the gravity direction according to the line-of-sight of the user 10 detected by the line-of-sight recognition sensor 57. Note that the processing of generating the video based on the gravity direction according to the line-of-sight of the user 10 may be executed by a processor such as a CPU included in the display 51 or may be processed by a video processing device different from the display 51 and a video signal after the processing may be supplied to the display 51. The reflection type polarizing plate 52 is directly fixed on the display surface of the display 51. Since the display 51 and the reflection type polarizing plate 52 are integrated, it is possible to omit a configuration in which the reflection type polarizing plate 52 is held in a state of being inclined.

The reflection type polarizing plate 52 is the same member as the reflection type polarizing plate 31 described with reference to FIG. 2, and is configured to transmit p-polarized light and reflect s-polarized light. When the video display unit of the display 51 includes an LCD, output light of the display 51 is linearly polarized light. Therefore, the reflection type polarizing plate 52 is bonded to the surface of the display 51 so that a polarization axis of the output light of the display 51 coincides with a transmission axis of the reflection type polarizing plate 52. In other words, the output light of the display 51 is p-polarized light matched with the transmission axis of the reflection type polarizing plate 52, and the reflection type polarizing plate 52 is configured to transmit the output light (hereinafter, also referred to as video light) of the display 51. Furthermore, the reflection type polarizing plate 52 is configured to reflect s-polarized subject light of light (subject light) from the user 10 as a subject, the light (subject light) including p-polarized light and s-polarized light. The reflected s-polarized subject light travels to the camera 53 installed vertically above the display 51 and the reflection type polarizing plate 52.

The camera 53 is installed vertically above the display 51 and the reflection type polarizing plate 52 while the camera 53 faces in a floor surface direction (downward direction). A black mask 54 is installed in front of (below) the camera 53 and between the camera 53 and the reflection type polarizing plate 52, and the polarizing filter 55 is installed between the black mask 54 and the camera 53. The black mask 54 is configured to absorb light and reduce reflection of light. The black mask 54 is provided with an opening 54C corresponding to an imaging range of the camera 53. The polarizing filter 55 is an absorption type polarizing element configured to selectively transmit linearly polarized light in a first direction and selectively absorb linearly polarized light in a second direction orthogonal to the first direction. The polarizing filter 55 is disposed in a direction in which the polarizing filter 55 transmits s-polarized light that is polarized light of the reflection axis of the reflection type polarizing plate 52 and absorbs p-polarized light.

The display 51 and the camera 53 are disposed so that an optical axis of the imaging center of the camera 53 coincides with an optical axis of the video light passing through the center of the display 51.

In the display device 41 configured as described above, the video light of display 51, the video light being p-polarized light, is transmitted through the reflection type polarizing plate 52 and is visually recognized by the user 10. Of the subject light of the user 10 including the p-polarized light and the s-polarized light, the s-polarized subject light is reflected by the reflection type polarizing plate 52, passes through the opening 54C of the black mask 54 and the polarizing filter 55, and enters the camera 53. The camera 53 is configured to capture an image of the subject light of the user 10 including the s-polarized light and generate a user image.

If characteristics of the display device 41 are described in correspondence with (1A) to (6A) of the display device 1 that is the comparative example described above, the characteristics are as described in the following (1B) to (6B).
(1B) The video light of the display 51 is p-polarized light and is not dimmed because a polarization direction of the video light of the display 51 is aligned with the transmission axis of the reflection type polarizing plate 52. Therefore, the video light of the display 51 can be delivered to the user 10 without being dimmed.
(2B) Of the subject light including the p-polarized light and the s-polarized light, the s-polarized subject light is reflected by the reflection type polarizing plate 52. Since a transmission axis of the polarizing filter 55 is also aligned with the s-polarized subject light, the s-polarized subject light is transmitted through the polarizing filter 55 and enters the camera 53, so that the camera 53 can capture an image of the user 10.
(3B) Since a scene on a side of the camera 53 is covered with the black mask 54, the scene is not easily visible to the user 10.
(4B) Since the video light of the display 51 is p-polarized light and is cut by the polarizing filter 55, an image of the video light is not captured by the camera 53.
(5B) The reflection type polarizing plate 52 is directly fixed to the display 51 and does not need to be fixed in the air.
(6B) Since the display surface of the display 51 coincides with a reflection surface of the subject light, there is no restriction on a visual distance of the user 10.

As described above, with the display device 41 of the first embodiment, the dimming of display light can be reduced by using the reflection type polarizing plate 52 without using a half mirror 12, so that the quality of a video on the display 51 to be presented to the user 10 can be improved, and the quality of the user image captured by the camera 53 can also be improved. It is achieved that the lowering of video quality is reduced and a line-of-sight direction of the user 10 viewing the video displayed on the display 51 is made coincide with and an imaging direction of the camera 53 capturing the user 10.

Compared with the display device 1 of the comparative example, since the display 51 and the reflection type polarizing plate 52 are integrated, it is possible to omit a configuration in which the reflection type polarizing plate 52 is held in a state of being inclined, and it is not necessary to darken to make invisible to the user 10, so that an excellent installation property is achieved. Since the black mask 54 is only on one surface of a ceiling, the black mask 54 can be made on a smaller scale than that of the display device 1 that requires at least two surfaces. Since the display 51 can be disposed in front of the user 10, a viewing distance can be shortened.

### 4. Modification Example of First Embodiment

A modification example of the first embodiment described above will be described. The display device 41 in FIG. 3 can take the following modification examples.

### First Modification Example

In the display device 41 of FIG. 3, the black mask 54 is installed in front of the camera 53. As a first modification example, instead of the black mask 54, a polarizing filter whose transmission axis is orthogonal to a polarizing filter 55, that is, a polarizing filter configured to transmit p-polarized light and absorb s-polarized light may be used. In this case, since the polarizing filter disposed in front of the polarizing filter 55 is configured to transmit p-polarized light, a part (p-polarized light) of light (for example, external light) from a side of a camera 53 in a ceiling direction is transmitted and incident on a side of a display 51, so that there is an advantage that an imaging environment becomes bright. Furthermore, the black mask 54 itself can be omitted depending on a surrounding environment where a display device 41 is installed.

### Second Modification Example

As a second modification example, a rotation mechanism capable of rotating a polarization axis by 90 degrees can be provided in a polarizing filter 55 disposed between a camera 53 and a black mask 54. In the direction of the polarizing filter 55 described with reference to FIG. 3, that is, in the direction in which the polarizing filter 55 transmits s-polarized light and absorbs p-polarized light, the polarizing filter 55 is configured to cut the video light of a display 51 and transmit the subject light of a user 10 as described above. When a rotation by 90 degrees from the direction described in FIG. 3 is performed by the rotation mechanism, the polarizing filter 55 is configured to cut the subject light of the user 10 and transmit the video light of the display 51. For example, a calibration image for confirming a temporal change in brightness, chromaticity, or the like is displayed on the display 51, and captured by the camera 53, whereby the temporal change in brightness, chromaticity, or the like can be calibrated.

### Third Modification Example

The display device 41 illustrated in FIG. 3 has a configuration in which the reflection type polarizing plate 52 is bonded to the entire surface of a display surface of the display 51, but the reflection type polarizing plate 52 does not need to be bonded to the entire surface of the display surface and is only required to be bonded to at least a region covering an imaging range of the camera 53. By reducing a bonding region (area) of the reflection type polarizing plate 52, extra reflected light (s-polarized light) reflected toward a side of the camera 53 is reduced. In accordance with this, a size (area) of a black mask 54 may be reduced, and the display device 41 can be further downsized.

### Fourth Modification Example

In the display device 41 described above, the display 51 includes the LCD, but a display other than the LCD, for example, an organic electroluminescent display (OLED), an LED display using a micro LED, a projector, a CRT display, or the like may be used as a display 51. When the display 51 is a display such that the display itself includes a polarizing plate and is configured to output a polarized wave as output light like the LCD described above, a reflection type polarizing plate 52 is bonded to a surface of the display 51 so that a polarization axis of the output light of the display 51 coincides with a transmission axis of the reflection type polarizing plate 52 as described above. The display 51 is not limited to a display configured to output a polarized wave as output light, but a display configured to output a polarized wave as output light is preferable because utilization efficiency of the output light becomes high.

### Fifth Modification Example

A polarizing filter 55 disposed between a camera 53 and a black mask 54 may be provided in an opening 54C of a black mask 54 and integrated with the black mask 54. In this case, the black mask 54 and the polarizing filter 55 can be thinned. Alternatively, a polarizing filter 55 may be attached to a tip of a lens of a camera 53 and integrated with the camera 53. Furthermore, the camera 53 may be a polarization camera in which a polarization element as a polarizing filter 55 is incorporated in an imaging sensor.

### Sixth Modification Example

A polarizing filter 55 disposed between a camera 53 and a black mask 54 may be a circular polarizing filter instead of a linear polarizing filter. The circularly polarizing filter can be configured by adding a ¼ phase difference plate to a linearly polarizing filter. A ¼ phase difference plate may be added to a front surface of the polarizing filter 55, or the polarizing filter 55 itself may be replaced with a circularly polarizing filter. When the camera 53 is a digital camera, since polarized light may be used for autofocus and exposure, it is common to use a circularly polarizing filter for normal operation.

### Seventh Modification Example

The number of cameras 53 is not limited to one and may be a plurality of cameras, for example, stereo cameras. Furthermore, the camera 53 is not limited to an RGB camera configured to capture an image of light having RGB wavelengths and may be an IR camera configured to capture an image of infrared light (IR light) or a UV camera configured to capture an image of UV light. In other words, a wavelength of subject light whose image is captured by the camera 53 is not limited.

Furthermore, the camera 53 is not limited to an image sensor configured to generates an image and may be a distance measuring camera (distance measuring sensor) configured to measure a distance to a subject (object). In a display device 41, since a reciprocating optical path to the subject (object) is not disturbed, a distance to a subject (object) can be measured by a ToF method.

### Eighth Modification Example

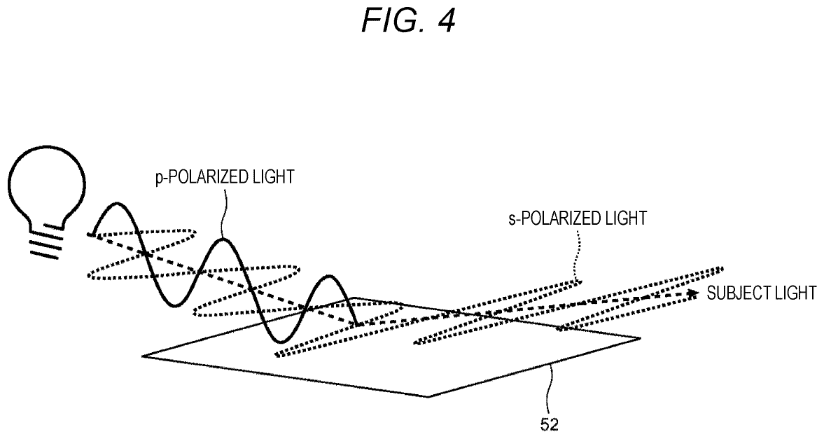

Either a direction of a transmission axis of a reflection type polarizing plate 52 and a direction of a reflection axis thereof maybe a lateral direction or a longitudinal direction. However, as illustrated in FIG. 4, it is desirable to dispose the reflection type polarizing plate 52 so that the reflection axis (axis of s-polarized light) is perpendicular to a flat surface formed by an optical axis of reflected light reflected by the reflection type polarizing plate 52, specifically, subject light. In general, in specular reflection, polarized light in a lateral direction with respect to a reflection direction of light becomes strong. Therefore, by employing such a disposition, the reflected light can be effectively utilized to brighten a captured image and the video light of a display 51.

### Ninth Modification Example

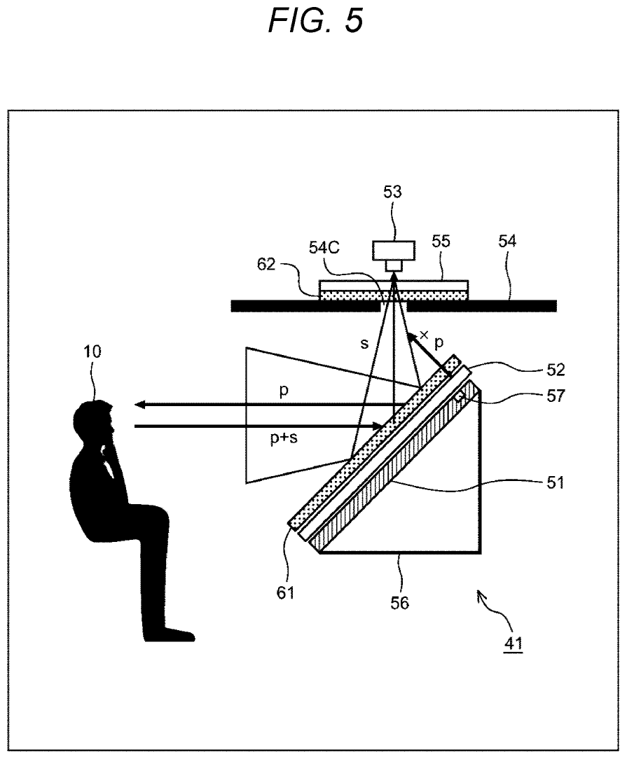

In the examples described above, examples in which the p-polarized light and the s-polarized light are linearly polarized light have been described, but the p-polarized light and the s-polarized light are not limited to linearly polarized light. For example, circularly polarized light or elliptically polarized light may be used. For example, when the p-polarized light and the s-polarized light are circularly polarized light, as illustrated in FIG. 5, a ¼ phase difference plate 61 and a ¼ phase difference plate 62 are only required to be disposed on front surfaces of a reflection type polarizing plate 52 and a polarizing filter 55, respectively. As a result, the p-polarized light and the s-polarized light are converted from the above-described linear polarized light in the lateral direction and the longitudinal direction into right-circularly polarized light and left-circularly polarized light. For example, the video light of a display 51 is right-circularly polarized light (left-circularly polarized light) as p-polarized light, and the subject light of a user 10 is left-circularly polarized light (right-circularly polarized light) as s-polarized light. Since circularly polarized light has a high oblique incidence characteristic, a captured image can have high contrast.

### 5. Second Embodiment of Display Device of Present Disclosure

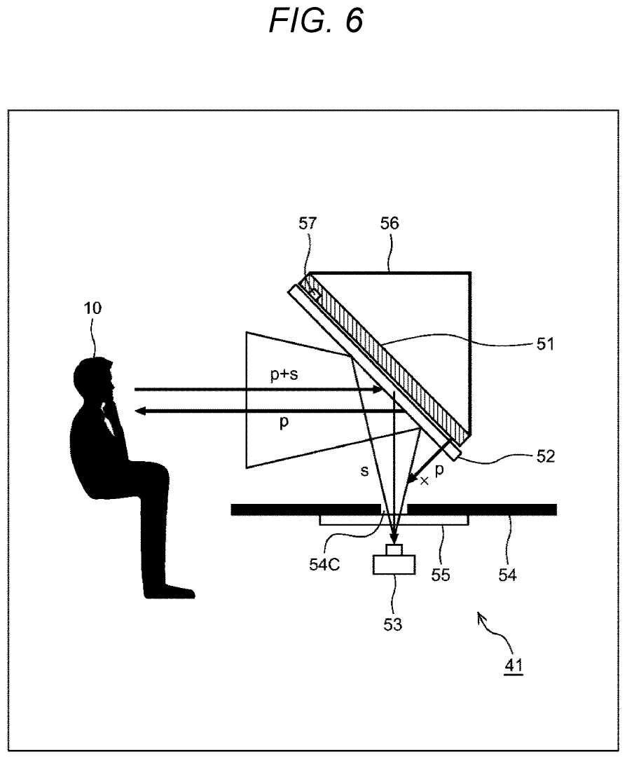

FIG. 6 is a side view illustrating a configuration example of a second embodiment of the display device of the present disclosure.

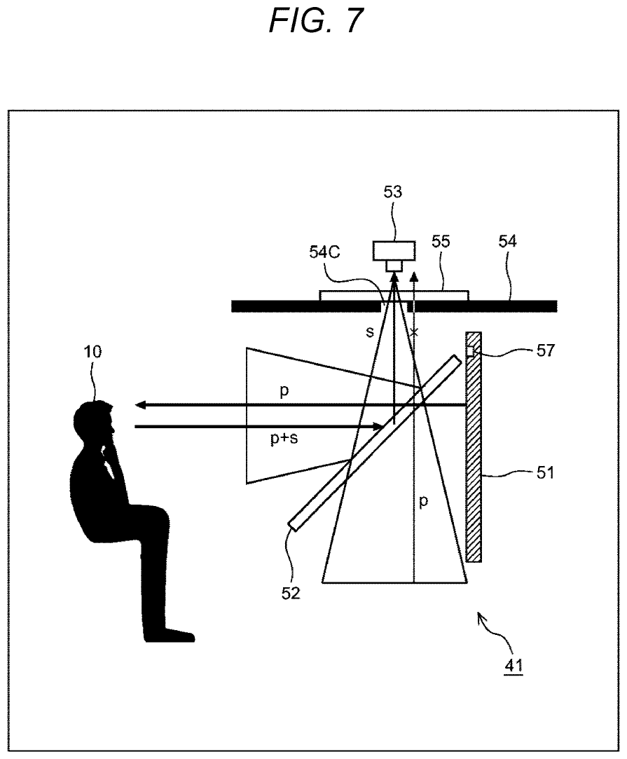

In FIG. 6, parts common to those of the first embodiment illustrated in FIG. 3 are denoted by the same reference numerals, and description of the parts will be omitted as appropriate. This similarly applies to third to fifth embodiments in FIGS. 7 to 9 as described later.

The first embodiment of FIG. 3 has a configuration in which the camera 53 is installed vertically above the display 51 and the reflection type polarizing plate 52, and the subject light of the user 10 is reflected to the upper side (ceiling side) by the reflection type polarizing plate 52.

Meanwhile, the second embodiment of FIG. 6 has a configuration in which a camera 53 is installed vertically below a display 51 and a reflection type polarizing plate 52, and the subject light of a user 10 is reflected by the reflection type polarizing plate 52 to a floor surface side (lower side). In this case, light shielding of a ceiling is unnecessary.

The display 51 is disposed at a position in front of the user and away by a predetermined distance while the display 51 is inclined and faces downward by 45 degrees, and the reflection type polarizing plate 52 is bonded to a surface of the display 51. The display 51 is attached to a fixing member 56, whereby the display 51 is disposed in a state of being inclined with respect to a surface perpendicular to a gravity direction.

The camera 53 is installed vertically below the display 51 and the reflection type polarizing plate 52 while facing in a ceiling direction (upward direction). A black mask 54 is installed in front of (above) the camera 53 and between the camera 53 and the reflection type polarizing plate 52, and a polarizing filter 55 is installed between the black mask 54 and the camera 53.

In a display device 41 of the second embodiment, the video light of the display 51, the video light being p-polarized light, is transmitted through the reflection type polarizing plate 52 and is visually recognized by the user 10. Of the subject light of the user 10 including the p-polarized light and the s-polarized light, the s-polarized subject light is reflected by the reflection type polarizing plate 52, passes through the opening 54C of the black mask 54 and the polarizing filter 55, and enters the camera 53. The camera 53 is configured to capture an image of the subject light of the user 10 including the s-polarized light and generate a user image.

Characteristics of the display device 41 of the second embodiment are as described in the following (1B) to (6B).
(1B) The video light of the display 51 is p-polarized light and is not dimmed because a polarization direction of the video light of the display 51 is aligned with the transmission axis of the reflection type polarizing plate 52. Therefore, the video light of the display 51 can be delivered to the user 10 without being dimmed.
(2B) Of the subject light including the p-polarized light and the s-polarized light, the s-polarized subject light is reflected by the reflection type polarizing plate 52. Since a transmission axis of the polarizing filter 55 is also aligned with the s-polarized subject light, the s-polarized subject light is transmitted through the polarizing filter 55 and enters the camera 53, so that the camera 53 can capture an image of the user 10.
(3B) Since a scene on a side of the camera 53 is covered with the black mask 54, the scene is not easily visible to the user 10.
(4B) Since the video light of the display 51 is p-polarized light and is cut by the polarizing filter 55, an image of the video light is not captured by the camera 53.
(5B) The reflection type polarizing plate 52 is directly fixed to the display 51 and does not need to be fixed in the air.
(6B) Since the display surface of the display 51 coincides with a reflection surface of the subject light, there is no restriction on a visual distance of the user 10.

As described above, also in the display device 41 of the second embodiment, the dimming of display light can be reduced by using the reflection type polarizing plate 52 without using a half mirror 12, so that the quality of a video on the display 51 to be presented to the user 10 can be improved, and the quality of the user image captured by the camera 53 can also be improved. It is achieved that the lowering of video quality is reduced and a line-of-sight direction of the user 10 viewing the video displayed on the display 51 is made coincide with and an imaging direction of the camera 53 capturing the user 10.

The first embodiment has a configuration in which the subject light of the user 10 is reflected upward, and in the second embodiment, the subject light is reflected downward. However, similarly, a configuration in which the subject light can be reflected rightward and a configuration in which the subject light can be reflected leftward are also possible.

Furthermore, an angle at which the subject light of the user 10 is reflected in the first and second embodiments is not limited to 45 degrees and may be any angle. For example, in FIG. 6, when the reflection type polarizing plate 52 faces the floor surface side more than 45 degrees, and the reflection type polarizing plate 52 and the polarizing filter 55 are set at angles such that the reflection type polarizing plate 52 and the polarizing filter 55 are close to being parallel to each other, the polarization directions are more likely to be aligned, so that there is an advantage that contrast is improved. Conversely, in FIG. 6, as the reflection type polarizing plate 52 faces an upper surface side by more than 45 degrees, a reflection surface becomes closer to being vertical, and an angle of incident of s-polarized light with respect to the reflection surface becomes smaller, the sensitivity of deviation of the reflection surface from a flat surface becomes smaller. In other words, as the reflection surface becomes closer to being vertical, even when flatness of the reflection surface is somewhat poor, distortion of an image can be reduced.

### 6. Third Embodiment of Display Device of Present Disclosure

FIG. 7 is a side view illustrating a configuration example of a third embodiment of the display device of the present disclosure.

The first embodiment illustrated in FIG. 3 has a configuration in which the reflection type polarizing plate 52 is bonded to the surface of the display 51 and the display 51 and the reflection type polarizing plate 52 are integrated.

Meanwhile, a display device 41 of the third embodiment in FIG. 7 has a configuration in which a display 51 and a reflection type polarizing plate 52 are separately provided.

Specifically, the reflection type polarizing plate 52 is disposed at a position in front of a user and away by a predetermined distance while the reflection type polarizing plate 52 is inclined so as to face upward by 45 degrees with respect to a surface perpendicular to a gravity direction. The reflection type polarizing plate 52 is fixed by a fixing unit (not illustrated). The display 51 is disposed while facing a user 10 and being perpendicular to a floor surface, in other words, parallel to the gravity direction. Other configurations are substantially similar to those in the first embodiment.

Characteristics of the display device 41 of the third embodiment are as in the following (1B) to (6B).
(1B) The video light of the display 51 is p-polarized light and is not dimmed because a polarization direction of the video light of the display 51 is aligned with the transmission axis of the reflection type polarizing plate 52. Therefore, the video light of the display 51 can be delivered to the user 10 without being dimmed.
(2B) Of the subject light including the p-polarized light and the s-polarized light, the s-polarized subject light is reflected by the reflection type polarizing plate 52. Since a transmission axis of the polarizing filter 55 is also aligned with the s-polarized subject light, the s-polarized subject light is transmitted through the polarizing filter 55 and enters the camera 53, so that the camera 53 can capture an image of the user 10.
(3B) Since a scene on a side of the camera 53 is covered with the black mask 54, the scene is not easily visible to the user 10.
(4B) As for external light from below the reflection type polarizing plate 52 (floor surface side), only p-polarized light corresponding to the transmission axis of the reflection type polarizing plate 52 is transmitted, but since the p-polarized light is cut by the polarizing filter 55, an image of the p-polarized light is not captured by the camera 53.
(5B) The reflection type polarizing plate 52 is fixed separately from the display 51.
(6B) Since the display 51 is disposed in front that faces the user 10, there is no restriction on a visual distance of the user 10.

As described above, also in the display device 41 of the third embodiment, the dimming of display light can be reduced by using the reflection type polarizing plate 52 without using a half mirror 12, so that the quality of a video on the display 51 to be presented to the user 10 can be improved, and the quality of a user image captured by the camera 53 can also be improved. It is achieved that the lowering of video quality is reduced and a line-of-sight direction of the user 10 viewing the video displayed on the display 51 is made coincide with and an imaging direction of the camera 53 capturing the user 10.

In the case of the third embodiment, since the display 51 is disposed to face the user 10, the display 51 may be a 2D display instead of a 3D display.

### 7. Fourth Embodiment of Display Device of Present Disclosure

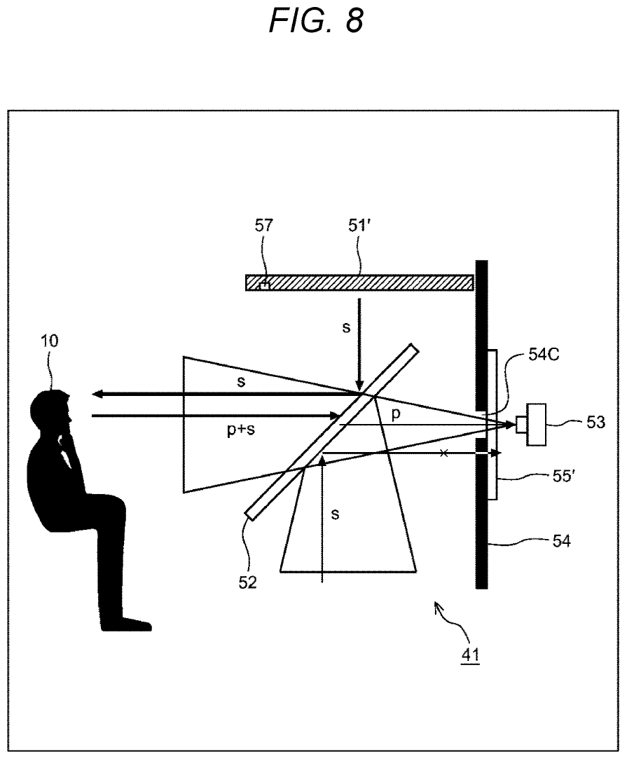

FIG. 8 is a side view illustrating a configuration example of a fourth embodiment of the display device of the present disclosure.

Similarly to the third embodiment illustrated in FIG. 7, the fourth embodiment in FIG. 8 has a configuration in which a display 51 and a reflection type polarizing plate 52 are separately disposed.

In the third embodiment illustrated in FIG. 7, the display 51 is disposed while facing the user 10, and the camera 53 is installed vertically above the reflection type polarizing plate 52. Meanwhile, in a display device 41 of the fourth embodiment in FIG. 8, a display 51′ is disposed vertically above a reflection type polarizing plate 52 with a display surface facing downward, and a camera 53 is installed while facing a user 10. The display 51′ of the fourth embodiment is different in a polarization axis of output light from the display 51 of each embodiment described above. While the output light of the display 51 is p-polarized light, the output light of the display 51′ is s-polarized light. Furthermore, a polarizing filter 55′ disposed in front of the camera 53 has a transmission axis different from that of the polarizing filter 55 of each embodiment described above. While the polarizing filter 55 is configured to transmit s-polarized light, the polarizing filter 55′ is configured to transmit p-polarized light.

Similarly to the other embodiments described above, the reflection type polarizing plate 52 is configured to reflect s-polarized light and transmit p-polarized light. Since video light from the display 51′ needs to be reflected by the reflection type polarizing plate 52 and the subject light of a user 10 needs to be transmitted, the video light of the display 51′ becomes s-polarized light and the subject light of the user 10 incident on the camera 53 becomes p-polarized light in the fourth embodiment. Therefore, a relationship between the s-polarized light and the p-polarized light of the video light of the display 51′ and the subject light of the user 10 is opposite to that in the first to third embodiments described above.

Characteristics of the display device 41 of the fourth embodiment are as described in the following (1B) to (6B).
(1B) The video light of the display 51′ is s-polarized light and is not dimmed because a polarization direction of the video light of the display 51′ is aligned with a reflection axis of the reflection type polarizing plate 52. Therefore, the video light of the display 51′ can be delivered to the user 10 without being dimmed.
(2B) Of the subject light including the p-polarized light and the s-polarized light, the p-polarized subject light is transmitted through the reflection type polarizing plate 52 and the polarizing filter 55′ and enters the camera 53, so that the camera 53 can capture an image of the user 10.
(3B) Since a scene on a side of the camera 53 is covered with the black mask 54, the scene is not easily visible to the user 10.
(4B) As for external light from below the reflection type polarizing plate 52 (floor surface side), s-polarized light corresponding to the reflection axis of the reflection type polarizing plate 52 is reflected, but since the s-polarized light is cut by the polarizing filter 55′, an image of the s-polarized light is not captured by the camera 53.
(5B) The reflection type polarizing plate 52 is fixed separately from the display 51′.
(6B) Since a virtual image on the display 51′ is located behind a reflection surface of the reflection type polarizing plate 52 and disposed in front that faces the user 10, a visual distance of the user 10 is restricted.

As described above, also in the display device 41 of the fourth embodiment, the dimming of display light can be reduced by using the reflection type polarizing plate 52 without using a half mirror 12, so that the quality of a video on the display 51′ to be presented to the user 10 can be improved, and the quality of the user image captured by the camera 53 can also be improved. It is achieved that the lowering of video quality is reduced and a line-of-sight direction of the user 10 viewing the video displayed on the display 51′ is made coincide with and an imaging direction of the camera 53 capturing the user 10.

In the case of the fourth embodiment, since the virtual image on the display 51′ is disposed to face the user 10, the display 51′ may be a 2D display instead of a 3D display.

### 8. Fifth Embodiment of Display Device of Present Disclosure

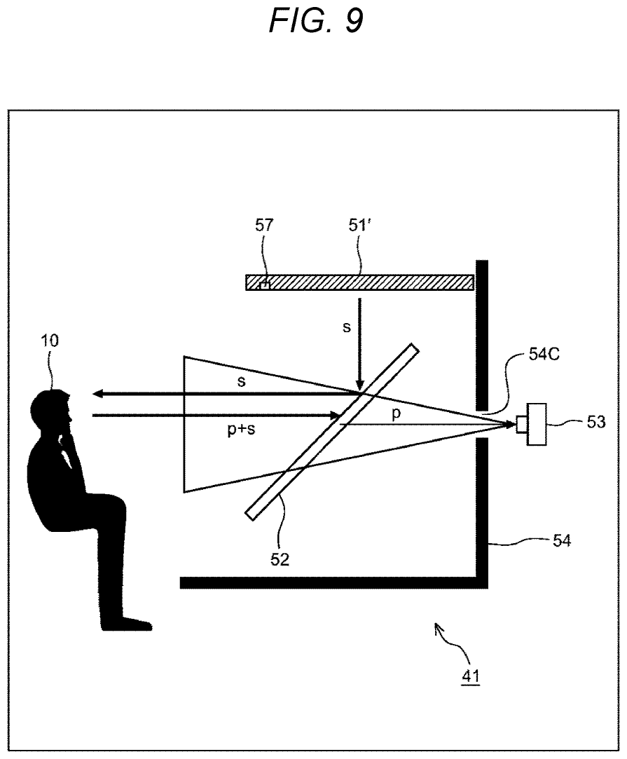

FIG. 9 is a side view illustrating a configuration example of a fifth embodiment of the display device of the present disclosure.

Similarly to the fourth embodiment illustrated in FIG. 8, the fifth embodiment in FIG. 9 has a configuration in which a display 51′ and a reflection type polarizing plate 52 are separately disposed apart from each other, the display 51′ configured to output s-polarized video light is disposed above the reflection type polarizing plate 52, and a camera 53 is disposed in front of a user 10 behind the reflection type polarizing plate 52.

There is omitted the polarizing filter 55′ disposed between the camera 53 and the black mask 54 in the fourth embodiment illustrated in FIG. 8, and a black mask 54 is disposed not only in front of the camera 53 but also on a floor surface vertically below the reflection type polarizing plate 52. Other configurations are similar to those of the fourth embodiment illustrated in FIG. 8.

Since the black mask 54 is disposed on the floor surface below the reflection type polarizing plate 52, the reflection of external light (including s-polarized light) below the reflection type polarizing plate 52 is reduced by the black mask 54 on the floor surface. As a result, the entry of the s-polarized light from a floor surface side into the reflection type polarizing plate 52 is reduced, so that the s-polarized light is prevented from being reflected by the reflection type polarizing plate 52 and entering the camera 53. Therefore, the polarizing filter 55′ in front of the camera 53 can be omitted.

Characteristics of a display device 41 of the fifth embodiment are as described in the following (1B) to (6B).
(1B) The video light of the display 51′ is s-polarized light and is not dimmed because a polarization direction of the video light of the display 51′ is aligned with a reflection axis of the reflection type polarizing plate 52. Therefore, the video light of the display 51′ can be delivered to the user 10 without being dimmed.
(2B) Of subject light including p-polarized light and s-polarized light, the p-polarized subject light is transmitted through the reflection type polarizing plate 52 and enters the camera 53, so that the camera 53 can capture an image of the user 10.
(3B) Since a scene on a side of the camera 53 is covered with the black mask 54, the scene is not easily visible to the user 10.
(4B) As for external light from below the reflection type polarizing plate 52 (floor surface side), since the floor surface is covered with the black mask 54, s-polarized light is not reflected by the reflection type polarizing plate 52 and is not incident on the camera 53 and an image of the s-polarized light is not captured by the camera 53. The polarizing filter 55′ disposed in front of the camera 53 is unnecessary.
(5B) The reflection type polarizing plate 52 is fixed separately from the display 51′.
(6B) Since a virtual image on the display 51′ is located behind a reflection surface of the reflection type polarizing plate 52 and disposed in front that faces the user 10, a visual distance of the user 10 is restricted.

As described above, also in the display device 41 of the fifth embodiment, the dimming of display light can be reduced by using the reflection type polarizing plate 52 without using a half mirror 12, so that the quality of a video on the display 51′ to be presented to the user 10 can be improved, and the quality of a user image captured by the camera 53 can also be improved. It is achieved that the lowering of video quality is reduced and a line-of-sight direction of the user 10 viewing the video displayed on the display 51′ is made coincide with and an imaging direction of the camera 53 capturing the user 10.

Also in the fifth embodiment, since the virtual image on the display 51′ is disposed to face the user 10, the display 51′ may be a 2D display instead of a 3D display.

### Application of Modification Examples

Also in the second to fifth embodiments, the first to ninth modification examples of the first embodiment described above can be applied.

### 9. Summary of Display Device of Present Disclosure

The display device 41 according to the first to fifth embodiments described above includes the display 51 (51′), the camera 53, and the reflection type polarizing plate 52 configured to selectively transmit first polarized light having a first polarization direction and selectively reflect second polarized light having a second polarization direction different from the first polarization direction. The reflection type polarizing plate 52 is disposed in the imaging direction of the camera 53 so that the reflection type polarizing plate 52 transmits one of an image of natural light including first polarized light and second polarized light and a video on the display 51 and reflects the other of the image of natural light and the video on the display 51, and the camera 53 is configured to capture the image of natural light including only one of the first polarized light and the second polarized light provided through the reflection type polarizing plate 52.

In the first to fifth embodiments, the first polarized light transmitted by the reflection type polarizing plate 52 is p-polarized light, and the second polarized light to be reflected is s-polarized light. The p-polarized light and the s-polarized light may be linearly polarized light, circularly polarized light, or elliptically polarized light. The image of natural light including the first polarized light and the second polarized light includes, for example, the subject light of the user 10 and external light. The p-polarized light transmitted by the reflection type polarizing plate 52 includes the video light of the display 51 in the first to third embodiments, and includes the subject light of the user 10 in the fourth and fifth embodiments. The s-polarized light reflected by the reflection type polarizing plate 52 includes the subject light of the user 10 in the first to third embodiments and includes the video light of the display 51′ in the fourth and fifth embodiments. The camera 53 is configured to capture an image of the user 10 as a subject including only the s-polarized light in the first to third embodiments and capture an image of the user 10 as a subject including only the p-polarized light in the fourth and fifth embodiments.

With the display device 41 according to the first to fifth embodiments, the dimming of the video light of the display 51 can be reduced by using the reflection type polarizing plate 52, so that the quality of the video on the display 51 to be presented to the user 10 can be improved. Furthermore, the quality of the user image captured by the camera 53 can also be improved. It is achieved that the lowering of video quality is reduced and a line-of-sight direction of the user 10 viewing the video displayed on the display 51 is made coincide with and an imaging direction of the camera 53 capturing the user 10. The display device 41 can be configured by a general-purpose member and can be achieved at a low cost.

As compared with the display device 1 of FIG. 1 using the half mirror 12, the display device 41 has an excellent installation property, high viewing luminance of the display 51, and no quality degradation of a displayed video and a captured video.

As compared with a type in which a camera is embedded in a display to make the line-of-sight direction of the user 10 coincide with the imaging direction of the camera 53, a special structure for embedding the camera in the display is not required and the video quality of the display does not deteriorate.

Since the line-of-sight direction of the user 10 and the imaging direction of the camera 53 capturing the user 10 coincide with each other, there is no need to perform image processing of converting a user image obtained by capturing an image of the user from an oblique direction into a front image.

### 10. Configuration Example of Video Conference System

The display device 41 described above can be applied to a device in which the video light of the display 51 and the imaging direction of the camera 53 need to coincide with each other, for example, a teleprompter, a head-up display used for in-vehicle applications, a head-mounted display, or the like. Furthermore, the display device 41 can also be applied to a telecommunication device or the like that enables one-to-one communication with a person at remote place or one-to-many communication with persons at remote places, such as a video conference system.

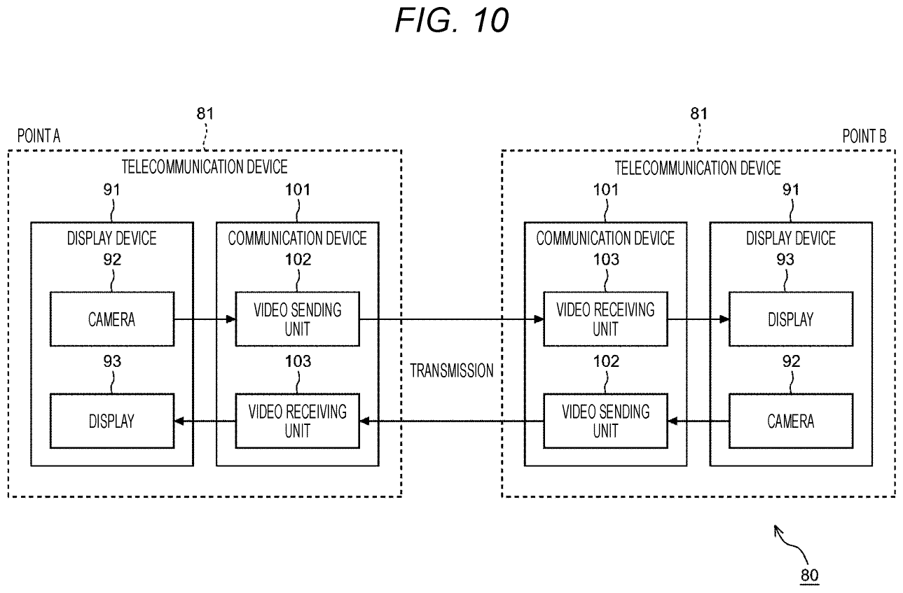

FIG. 10 is a block diagram of a video conference system including a telecommunication device to which the display device of the present disclosure is applied.

A video conference system 80 in FIG. 10 is a system for users who are at distant places that are a point A and a point B to hold a video conference. The same telecommunication devices 81 are installed at the point A and the point B.

The telecommunication device 81 includes at least a display device 91 and a communication device 101. The display device 91 includes at least a camera 92 and a display 93. The communication device 101 includes at least a video sending unit 102 and a video receiving unit 103. The two telecommunication devices 81 are connected through a predetermined network, for example, the Internet, a local area network (LAN), a wide area network (WAN), a mobile communication network, or the like.

The display device 91 corresponds to the display device 41 described above, the camera 92 corresponds to the camera 53 of the display device 41, and the display 93 corresponds to the display 51 or 51′ of the display device 41. A user image captured by the camera 92 is supplied to the video sending unit 102. The video sending unit 102 is configured to send the user image to a communication device 101 of another telecommunication device 81 that is a communication partner through a network. The video receiving unit 103 is configured to receive the user image obtained by capturing an image of a user who is the communication partner, the image having been sent through the network from the communication device 101 of the another telecommunication device 81 that is the communication partner, and the video receiving unit 103 is configured to supply the user image to the display 93. The display 93 is configured to display the user image received by the video receiving unit 103.

As described above, the display device 41 described above is adopted as the display device 91 of the telecommunication device 81, whereby it is possible to achieve the video conference system 80 in which the lowering of video quality is reduced, and a line-of-sight direction of the user viewing a video displayed on the display 93 and an imaging direction of the camera 92 capturing the user are made coincide with each other. Although an example of FIG. 10 has been described with a one-to-one configuration for the sake of simplicity, this similarly applies to a case where a video conference is held by connecting three or more telecommunication devices 81 through a network.

In the present description, a system means a set of a plurality of components (devices, modules (parts), and the like), and it does not matter whether or not all the components are in the same housing. Therefore, a plurality of devices housed in separate housings and connected to each other through a network and one device in which a plurality of modules is housed in one housing are both systems.

The embodiments of the present disclosure are not limited to the embodiments described above and various modifications may be made without departing from the gist of the technology of the present disclosure.

For example, a form in which all or some of the plurality of embodiments and modification examples described above are combined can be appropriately adopted.

Note that the effects described in the present specification are merely examples and are not limited, and there may be effects other than those described in the present specification.

Note that the technology of the present disclosure can have the following configurations.

(1)

A display device including:
a display;
a camera; and
a reflection type polarizing plate configured to selectively transmit first polarized light having a first polarization direction and selectively reflect second polarized light having a second polarization direction different from the first polarization direction, in which
the reflection type polarizing plate is disposed in an imaging direction of the camera so that the reflection type polarizing plate transmits one of an image of natural light including the first polarized light and the second polarized light and a video on the display and reflects the other of the image of natural light and the video on the display, and
the camera is configured to capture the image of natural light including only one of the first polarized light and the second polarized light provided through the reflection type polarizing plate.
   (2)

The display device according to the (1), in which
the display is disposed in a state of being inclined with respect to a surface perpendicular to a gravity direction, and
the reflection type polarizing plate is directly fixed on a display surface of the display.
   (3)

The display device according to the (2), further including
a line-of-sight recognition sensor configured to recognize a line-of-sight of a viewer of the display, in which
the display is configured to generate a video based on the gravity direction according to the recognized line-of-sight.
   (4)

The display device according to the (2) or (3), in which
the display is disposed in a state of being inclined while facing upward, and
the imaging direction of the camera is a floor surface direction.
   (5)

The display device according to the (2) or (3), in which
the display is disposed in a state of being inclined while facing downward, and
the imaging direction of the camera is a ceiling direction.
   (6)

The display device according to any one of the (1) to (5), further including
a polarizing filter between the camera and the reflection type polarizing plate, in which
the polarizing filter is configured to transmit the image of natural light including only one of the first polarized light and the second polarized light provided through the reflection type polarizing plate, the image of natural light being captured by the camera.
   (7)

The display device according to the (6), further including
a black mask configured to reduce reflection of light, the black mask being between the polarizing filter and the reflection type polarizing plate.
   (8)

The display device according to the (6), further including
a second polarizing filter having a transmission axis orthogonal to the polarizing filter, the second polarizing filter being between the polarizing filter and the reflection type polarizing plate.
   (9)

The display device according to any one of the (6) to (8), in which
the polarizing filter is configured to be capable of rotating a polarization axis by 90 degrees.
   (10)

The display device according to any one of the (1) to (9), further including
a black mask configured to reduce reflection of light, the black mask being between the camera and the reflection type polarizing plate.
   (11)

The display device according to the (10), in which
the black mask is further disposed vertically below the reflection type polarizing plate.
   (12)

The display device according to any one of the (1) to (11), in which
the reflection type polarizing plate is disposed in a state of being inclined with respect to a surface perpendicular to a gravity direction, and
the display is disposed in parallel to the gravity direction.
   (13)

The display device according to any one of the (1) to (11), in which
the reflection type polarizing plate is disposed in a state of being inclined with respect to a surface perpendicular to a gravity direction, and
the display is disposed vertically above the reflection type polarizing plate with a display surface facing downward.
   (14)

The display device according to any one of the (1) to (13), in which
the reflection type polarizing plate is configured to transmit the video on the display and reflect the image of natural light.
   (15)

The display device according to any one of the (1) to (13), in which
the reflection type polarizing plate is configured to reflect the video on the display and transmit the image of natural light.
   (16)

The display device according to any one of the (1) to (15), further including
a ¼ phase difference plate disposed on a front surface of the reflection type polarizing plate.
   (17)

The display device according to any one of the (1) to (15), further including:
a polarizing filter disposed between the camera and the reflection type polarizing plate; and
a ¼ phase difference plate disposed on a front surface of each of the reflection type polarizing plate and the polarizing filter.
   (18)

The display device according to any one of the (1) to (17), in which
in the display, a stereoscopic optical member is disposed on a front surface of a video display unit, and the display is configured to output the video with the first polarized light or the second polarized light.
   (19)

The display device according to any one of the (1) to (18), in which
a reflection axis of the reflection type polarizing plate is perpendicular to a flat surface formed by an optical axis of reflected light reflected by the reflection type polarizing plate.
   (20)

The display device according to any one of the (1) to (19), in which
the display and the camera are disposed so that an optical axis of an imaging center of the camera coincides with an optical axis of video light passing through a center of the display.

### REFERENCE SIGNS LIST

31 Reflection type polarizing plate
41 Display device
51, 51′ Display
52 Reflection type polarizing plate
53 Camera
54 Black mask
54C Opening
55, 55′ Polarizing filter
56 Fixing member
57 Line-of-sight recognition sensor
61 ¼ phase difference plate

1. A display device comprising:
a display;
a camera; and
a reflection type polarizing plate configured to selectively transmit first polarized light having a first polarization direction and selectively reflect second polarized light having a second polarization direction different from the first polarization direction, wherein
the reflection type polarizing plate is disposed in an imaging direction of the camera so that the reflection type polarizing plate transmits one of an image of natural light including the first polarized light and the second polarized light and a video on the display and reflects the other of the image of natural light and the video on the display, and
the camera is configured to capture the image of natural light including only one of the first polarized light and the second polarized light provided through the reflection type polarizing plate.

2. The display device according to claim 1, wherein
the display is disposed in a state of being inclined with respect to a surface perpendicular to a gravity direction, and
the reflection type polarizing plate is directly fixed on a display surface of the display.

3. The display device according to claim 2, further comprising
a line-of-sight recognition sensor configured to recognize a line-of-sight of a viewer of the display, wherein
the display is configured to generate a video based on the gravity direction according to the recognized line-of-sight.

4. The display device according to claim 2, wherein
the display is disposed in a state of being inclined while facing upward, and
the imaging direction of the camera is a floor surface direction.

5. The display device according to claim 2, wherein
the display is disposed in a state of being inclined while facing downward, and
the imaging direction of the camera is a ceiling direction.

6. The display device according to claim 1, further comprising
a polarizing filter between the camera and the reflection type polarizing plate, wherein
the polarizing filter is configured to transmit the image of natural light including only one of the first polarized light and the second polarized light provided through the reflection type polarizing plate, the image of natural light being captured by the camera.

7. The display device according to claim 6, further comprising
a black mask configured to reduce reflection of light, the black mask being between the polarizing filter and the reflection type polarizing plate.

8. The display device according to claim 6, further comprising
a second polarizing filter having a transmission axis orthogonal to the polarizing filter, the second polarizing filter being between the polarizing filter and the reflection type polarizing plate.

9. The display device according to claim 6, wherein
the polarizing filter is configured to be capable of rotating a polarization axis by 90 degrees.

10. The display device according to claim 1, further comprising
a black mask configured to reduce reflection of light, the black mask being between the camera and the reflection type polarizing plate.

11. The display device according to claim 10, wherein
the black mask is further disposed vertically below the reflection type polarizing plate.

12. The display device according to claim 1, wherein
the reflection type polarizing plate is disposed in a state of being inclined with respect to a surface perpendicular to a gravity direction, and
the display is disposed in parallel to the gravity direction.

13. The display device according to claim 1, wherein
the reflection type polarizing plate is disposed in a state of being inclined with respect to a surface perpendicular to a gravity direction, and
the display is disposed vertically above the reflection type polarizing plate with a display surface facing downward.

14. The display device according to claim 1, wherein
the reflection type polarizing plate is configured to transmit the video on the display and reflect the image of natural light.

15. The display device according to claim 1, wherein
the reflection type polarizing plate is configured to reflect the video on the display and transmit the image of natural light.

16. The display device according to claim 1, further comprising
a ¼ phase difference plate disposed on a front surface of the reflection type polarizing plate.

17. The display device according to claim 1, further comprising:
a polarizing filter disposed between the camera and the reflection type polarizing plate; and
a ¼ phase difference plate disposed on a front surface of each of the reflection type polarizing plate and the polarizing filter.

18. The display device according to claim 1, wherein
in the display, a stereoscopic optical member is disposed on a front surface of a video display unit, and the display is configured to output the video with the first polarized light or the second polarized light.

19. The display device according to claim 1, wherein
a reflection axis of the reflection type polarizing plate is perpendicular to a flat surface formed by an optical axis of reflected light reflected by the reflection type polarizing plate.

20. The display device according to claim 1, wherein
the display and the camera are disposed so that an optical axis of an imaging center of the camera coincides with an optical axis of video light passing through a center of the display.
